(19) United States
(12) Patent Application Publication
(10) Pub. No.: US 2005/0141362 A1
(43) Pub. Date: Jun. 30, 2005

(54) Method of seeking in optical disk drive

(75) Inventors: Ying-Ta Lin, Taipei (TW); Ren-Te Lin, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/022,859

(22) Filed: Dec. 28, 2004

(30) Foreign Application Priority Data
Dec. 29, 2003 (TW) 92137351

(51) Int. Cl. G11B 7/00

(52) U.S. Cl. 369/44.28

(57) ABSTRACT

The present invention discloses a method of improving seeking precision in an optical disk drive. Determine whether or not a center error signal is within a predetermined range when a short seek command is issued by the servo system. If not, the seek function is executed after a predetermined time.

This application claims the benefit of Taiwan application Serial No. 92137351, filed Dec. 29, 2003, the subject matter of which is incorporated herein by reference.

### BACKGROUND OF THE INVENTION

1. Field of the Invention

The invention relates in general to a method of improving seeking precision, and more particularly to an applicable method of improving the seek function in an optical disk drive.

2. Description of the Related Art

Normally, when an optical disk drive receives a reading/writing command issued by the host, the seeking servo executes a seek function first, i.e., moving the optical pick-up head to the target track indicated by the server system. After the optical pick-up head has reached the target track (i.e., on track), the optical disk drive accesses the disk.

There are two categories of seeking: the long seek and the short seek. Seeking with a distance of a few hundred tracks is considered as a short seek, while that of a few thousand tracks is considered as a long seek. Take the seeking of 10,000 tracks for example, the seeking servo executes a long seek first, such as 9,500 tracks, then executes a short seek to precisely control the optical pick-up head to reach the target track.

When seeking, the server system adopts a tracking error signal TE to determine the number of seeking tracks and the direction of seeking. Referring to FIG. 1, a diagram of relevant signals during seeking is shown.

The tracking error signal TE is generated via some operations of the reflected light from the disk. During seeking, the tracking error signal TE represents the number of tracks that the optical pick-up head has passed through. When the optical pick-up head crosses over a track (i.e., from point A to point C), the tracking error signal TE crosses over zero cross point B to present a sine wave. So, the number of tracks that the optical pick-up head has passed through can be obtained via the calculation of the number of sine wave periods of the tracking error signal as shown in FIG. 1. In other words, if the optical pick-up head has crossed over 500 tracks, the tracking error signal should have the occurrences of 500 since wave periods.

In order to achieve a higher precision of seeking, the system design adopts TEZC and RFZC signal to calculate the direction of seeking. The TEZC is obtained via the quantization of the comparison of the tracking error signal TE and low-pass filtered tracking error signal (TELPF). Similarly, the RFZC is obtained via similar processing of the radio frequency signal (RFRP).

When the optical pick-up head moves outwards from the inner tracks of the optical disk, take time point A for instance, phase difference exists between TEZC signal and RFZC signal. If the RFZC leads the TEZC by 90 degrees, this means the optical pick-up head moves towards the outer tracks of the optical disk from the inner tracks of the optical disk. To the contrary, if the TEZC leads the RFZC by 90 degrees, this means the optical pick-up head moves towards the inner tracks of the optical disk from the outer tracks of the optical disk.

During seeking, the seeking servo uses the tracking error signal TE to calculate the number of tracks passed by and uses the phase difference between the TEZC and the RFZC to determine whether the direction of seeking is correct. So the quality of the tracking error signal TE influences the precision of seeking.

Normally, the quality of the tracking error signal TE has much to do with the relative position of the optical pick-up head and the sled. Referring to FIG. 2, a diagram of an optical pick-up head module is shown. Optical pick-up head module 1 includes an optical pick-up head 3, an elastic element 5, a sled 7 and a Laser diode (not shown here). If the optical pick-up head 3 is not disposed at the central position of the sled 7, such as P1 or P2 in the diagram, the sine wave pattern of the tracking error signal TE becomes more difficult to recognize because the photo path received by the photo detector of the optical pick-up head 3 is not the best one, consequently, the correct value of the TEZC and the RFZC becomes more difficult to obtain as well. During seeking, if the optical pick-up head 3 is not disposed at the central position of sled 7, focus fail occurs easily and the tracking error signal TE becomes difficult to recognize. Under such circumstances, it would be impractical to determine the direction of seeking because the phase difference between the TEZC and the RFZC cannot be determined, either.

Moreover, when accessing an unbalance disk, the optical pick-up head 3 wobbles due to disk eccentricity. This easily leads to a skewed tracking error signal TE, resulting in a misled judgment of the number of seeking tracks and the direction of seeking.

The above circumstances affect the seek function in an optical disk drive severely. If the optical pick-up head cannot be positioned on the target track during seeking, tracking will require a longer time or even come out with failure. Therefore the optical disk drive according to prior art needs a method of improving the seek function for correctly positioning the optical pick-up head on the target track during seeking to facilitate subsequent data accessing.

### SUMMARY OF THE INVENTION

It is therefore an object of the invention to provide a precise method of seeking in an optical disk drive for solving the problem caused by the the unbalance disk.

The invention achieves the above-identified object by providing a method of improving the seeking precision in an optical disk drive so as to resolve the problem of seek function in accessing an eccentric optical disk.

The invention provides a method of improving the seeking precision in an optical disk drive. When a short seek command is issued by the servo system, whether or not a center error signal is within a predetermined range is determined. If not, the seek function is executed after a predetermined time.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram of relevant signals during seeking;

FIG. 2 is a diagram of an optical pick-up head module;

FIG. 3 is a flowchart of a method of improving the seek function according to the invention; and

FIG. 4 is a wave pattern of a center error signal.

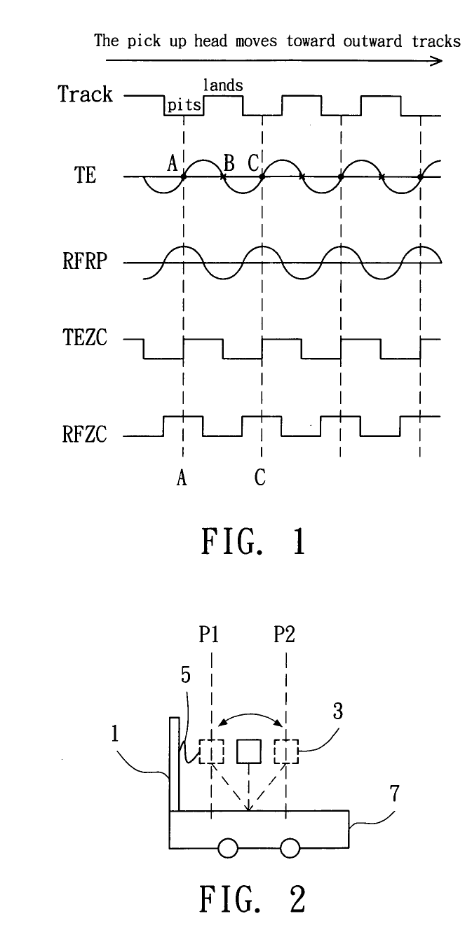

### DETAILED DESCRIPTION OF THE INVENTION

The eccentricity of the disk causes the optical pick-up head to wobble, resulting in a skewed tracking error signal, leading to a misled judgment of the number of seeking tracks and the direction of seeking. This is disadvantageous to the execution of tracking after seeking, because tracking requires a longer time or even fails. Consequently, the optical disk drive spends more time in accessing data. To overcome the above problems, the invention provides a method of improving the seeking precision in an optical disk drive.

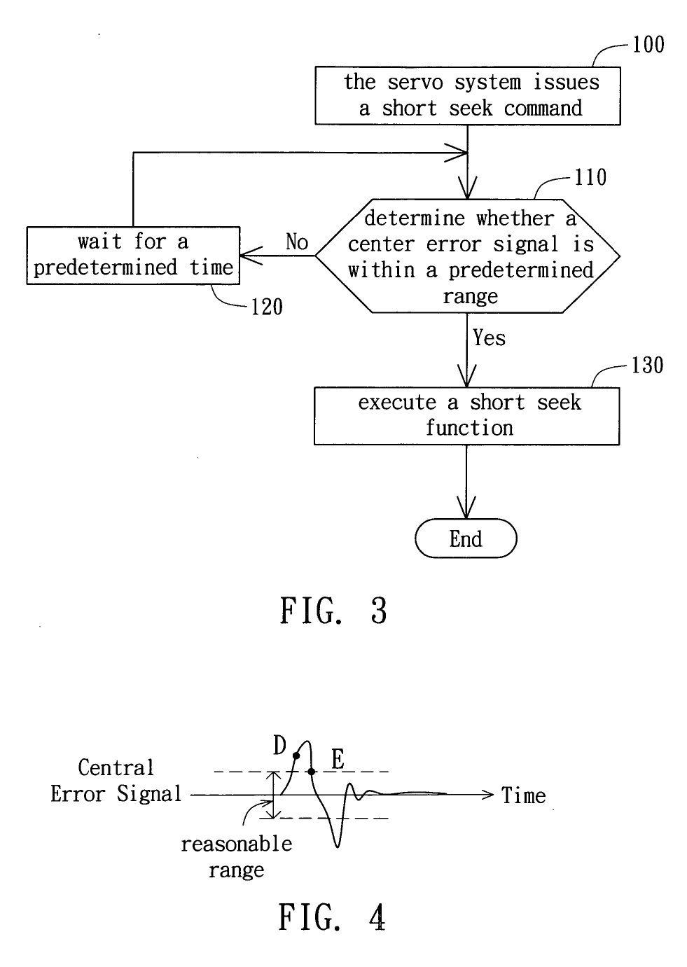

Referring to FIG. 3, a flowchart of a method of improving the seek function according to the invention is shown.

Step 100: the servo system issues a short seek command.

Step 110: determine whether a center error signal is within a predetermined range or not: if so, proceed to step 130, otherwise, proceed to step 120.

Step 120: wait for a predetermined time, return to step 110, and detect the center error signal again.

Step 130: execute a short seek.

When a short seek command is issued by the servo system, the procedure of the method is started. Meanwhile, determine whether a center error signal is within the predetermined range or not before the short seek is executed (step 110).

The center error signal indicates the position of the optical pick-up head within a removable range on the sled. If the center error signal is at the zero cross point, this means the optical pick-up head is at the center of the removable range. Otherwise, if the center error signal is far off the zero cross point, this means the optical pick-up head is far off the central position of removable range. Determine whether the center error signal is within the predetermined range before the short seek is executed.

Referring to FIG. 4, a wave pattern of a center error signal is shown. If the detected center error signal is D, this means the center error signal is not within the predetermined range, in other words, the optical pick-up head is far off the central position of the sled. Meanwhile, the tracking error signal is very difficult to recognize, if seeking is executed disregarding the above circumstance, seek fail might occur. Therefore, the center error signal detected is not within the predetermined range, the method will wait for a predetermined time (step 120). Since the optical pick-up head swings in a natural frequency until natural damping causes the swinging of the optical pick-up head fades and returns to the central position of the removable range without any external force applied. Generally the optical pick-up head returns to the central position of removable range for short, i.e., a few microseconds, so the efficiency of accessing data by the optical disk drive will not be affected. The seek function is executed after the center error signal is confirmed to be within the predetermined range (step 130).

The above center error signal is just an exemplification of the invention. Any signals that can detect the position of the optical pick-up head can be used to replace the application of the center error signal.

Therefore, the advantage of the invention lies in detecting the position of the optical pick-up head before seeing is executed. If the position of the optical pick-up head is within the predetermined rang, the optical disk drive waits for a period of time for the optical pick-up head to return to the central position of a removable range then executes the seek function. Since the tracking error signal is so recognizable, the number of seeking tracks and the direction of seeking can be determined and seek fail does not occur. Consequently, the seek function can be effectively improved.

Moreover, the invention has another advantage of effectively improving the seeking precision by means of the procedure of the method without causing the optical disk drive to slow down.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of improving seeking precision in an optical disk drive, comprising the steps of:
determining whether a predetermined signal is within a predetermined range when a short seek command is issued by a servo system of the optical disk drive; and
if the predetermined signal is not within the predetermined range, executing a seek function after a predetermined time.

2. The method according to claim 1, wherein the predetermined signal is a center error signal.

3. A method of seeking in an optical disk drive, comprising the steps of:
detecting a predetermined signal when a short seek command is issued by the servo system; and
executing a seek function only when the predetermined signal is within a predetermined range.

4. The method according to claim 3 further comprising:
if the predetermined signal is not within the predetermined range, then waiting a predetermined time for the predetermined signal to be within the predetermined range.

5. The method according to claim 3, wherein the predetermined signal is a center error signal.
